(19) United States
(12) Patent Application Publication
(10) Pub. No.: US 2009/0188424 A1
(43) Pub. Date: Jul. 30, 2009

(54) Bookmark

(76) Inventor: Robin McCormick Pickens, Woodland Hills, CA (US)

Correspondence Address: BRINKS HOFER GILSON & LIONE, P.O. BOX 10395, CHICAGO, IL, 60610, US

(21) Appl. No.: 12/291,795

(22) Filed: Nov. 13, 2008

Related U.S. Application Data
(60) Provisional application No. 61/003,154, filed on Nov. 14, 2007.

(51) Int. Cl. B42D 9/00

(52) U.S. Cl. 116/234

(57) ABSTRACT

A bookmark having a frame with at least three legs joined together in a serial manner; and a decorative piece attached to one of the at least three legs of the frame.

This application claims the benefit of priority under 35 U.S.C. § 119(e)(1) from U.S. Provisional Application No. 61/003,154 filed Nov. 14, 2007, the entire contents of which is incorporated herein by reference.

### BACKGROUND OF THE INVENTION

1. Field of the Invention

The present invention relates to the field of visual indicators used for locating a position, in particular, bookmarks.

2. Discussion of Related Art

The use of bookmarks is known in the prior art. Prior bookmarks had a tendency to be static and/or lack an ornamental character.

Accordingly, there is a need for a bookmark that provides an ornamental character and can use dynamically moving elements.

### SUMMARY OF THE INVENTION

One aspect of the present invention regards a bookmark that includes a frame having at least three legs joined together in a serial manner and a decorative piece attached to one of the at least three legs of the frame.

Another aspect of the present invention regards a bookmark that includes a frame having at least three legs joined together in a serial manner and a textual cover that is disposed on a portion of the frame. The bookmark may further have a decorative piece attached to the frame.

Another aspect of the present invention regards a method of using a bookmark, including providing a bookmark that includes a frame having at least three legs joined together in a serial manner and a decorative piece attached to one of the at least three legs of the frame. The method further includes using the bookmark to mark a page location among pages of a document. The bookmark may further include disposing a textual cover on a portion of the frame.

Another aspect of the present invention regards a method of using a bookmark, including providing a bookmark that includes a frame having at least three legs joined together in a serial manner and a textual cover that is disposed on a portion of the frame. The bookmark may further include attaching a decorative piece attached to the frame.

One or more of the above aspects of the present invention provide the advantage of a bookmark that has an ornamental character and can use dynamically moving elements.

The present invention, together with attendant objects and advantages, will be best understood with reference to the detailed description below in connection with the attached drawings.

### BRIEF DESCRIPTION OF THE DRAWINGS

FIG. 1 illustrates a bookmark of the present invention;

FIG. 2 depicts a frame and textual cover prior to assembling a bookmark of the present invention;

FIG. 3 depicts a frame and a textual cover prior to assembling a bookmark of the present invention in another embodiment;

FIG. 4 depicts the step of placing the frame within the textual cover;

FIG. 5 depicts the step of placing the frame within the textual cover in another embodiment;

FIG. 6 depicts the step of folding the textual cover around the frame according to an embodiment of the present invention;

FIG. 7 depicts the step of securing the textual cover around the frame according to an embodiment of the present invention;

FIG. 8 depicts an embodiment of the present invention having one decorative piece secured to the frame;

FIG. 9 depicts an embodiment of the present invention having three decorative pieces secured to the frame;

FIG. 10 depicts an embodiment of the present invention where the decorative pieces are attached to the hanging arm using various means;

FIG. 11 depicts an embodiment of the present invention where the decorative pieces are attached to the hanging arm using various means and the hanging arms are secured in place by stoppers; and

FIG. 12 depicts an embodiment of the present invention where a decorative piece is secured to a textual cover overlaying a frame.

### DETAILED DESCRIPTION OF THE PREFERRED EMBODIMENTS

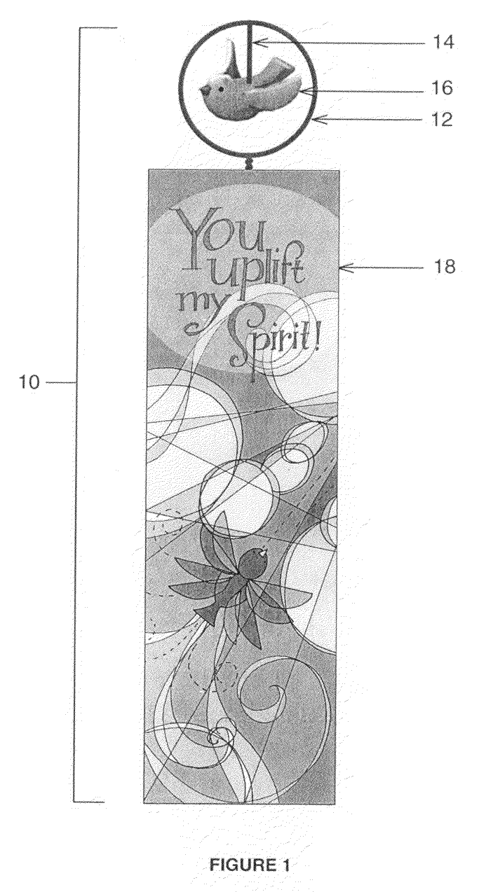

The structure and features of the bookmark of the present invention and method of using the bookmark of the present invention are best understood with reference to the drawings. FIG. 1 shows the basic construction of the bookmark 10. A frame 12 provides the underlying of the structure of the bookmark 10. The frame 12 may be composed of a wire or a semi-rigid plastic material. In one embodiment, the frame is an 18 gauge floral stem wire. The frame 12 may be one continuous material or it may be comprised of pieces attached together. In this embodiment, the frame 12 has a substantially rectangular base and is twisted into a configuration resembling a dotted “i”. In the embodiment shown in FIG. 1, a hanging arm 14 is attached to the top of frame 12. In this embodiment, the hanging arm 14 is securely attached to the frame 12 such that the hanging arm does not move. A decorative piece 16 is attached to the hanging arm 14. In one embodiment, the hanging arm 14 is welded to the frame 12. The textual cover 18 is disposed over the rectangular portion of the frame 12. The textual cover may include any suitable textile or sheet of plastic.

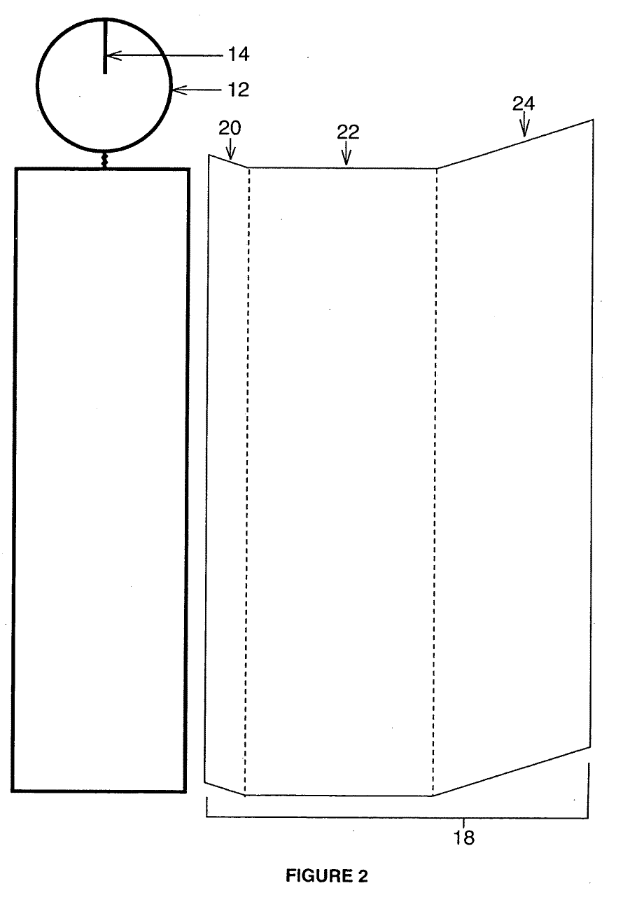

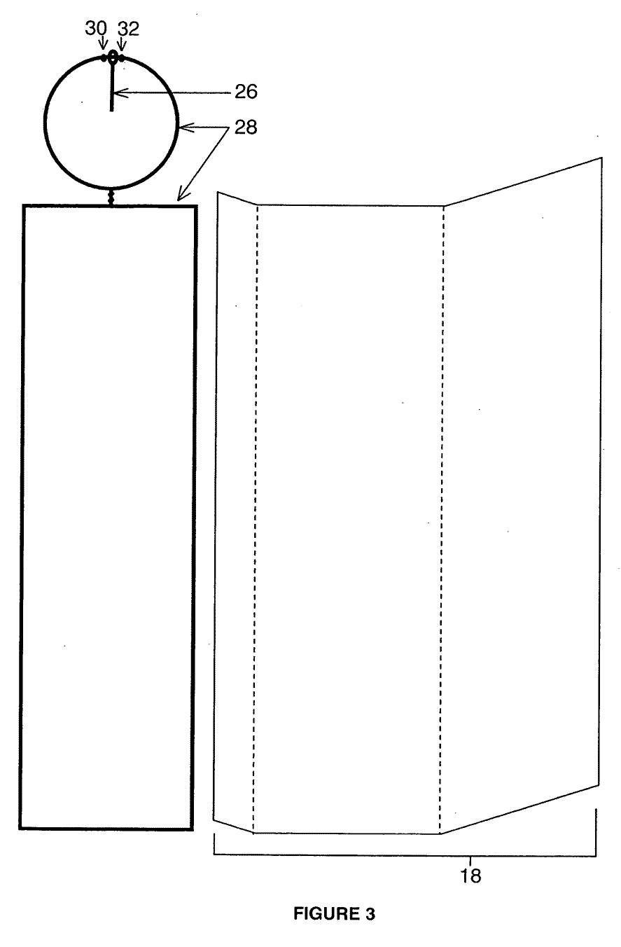

FIGS. 2-7 illustrate the process of constructing a bookmark of the present invention. FIG. 2 displays the frame 12 along side the textual cover 18. A hanging arm 14 is attached to the frame 12. The textual cover 18 is folded into three portions, the first portion 20 and a second portion 22 and a third portion 24, both the second portion 22 and the third portion 24 sized substantially the same as the width of the frame 12. FIG. 3 shows an additional embodiment of the present invention, in which the hanging arm 26 is not securely attached to the frame 28, but is attached in a manner to allow the hanging arm 26 to swing forwards and backwards. Two stoppers 30, 32 prevent the hanging arm 26 from sliding down the frame 28. In another embodiment, the hanging arm may be secured to the frame by coiling the hanging arm around the frame in a manner that allows the hanging arm to swing.

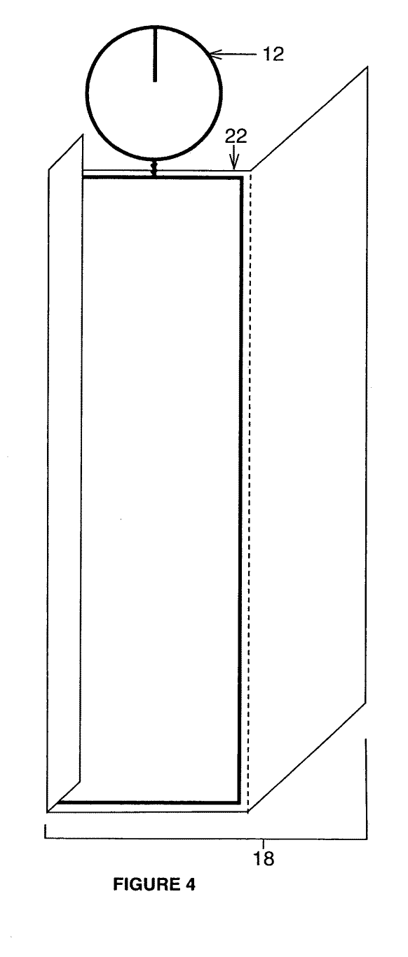

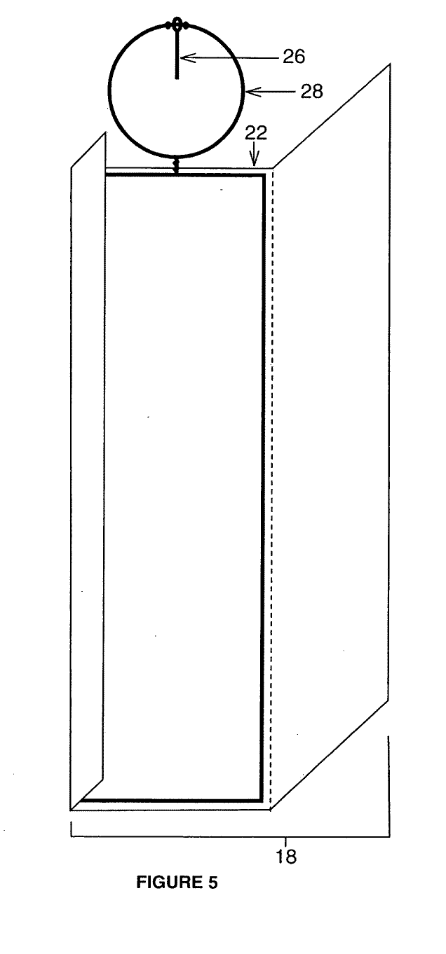

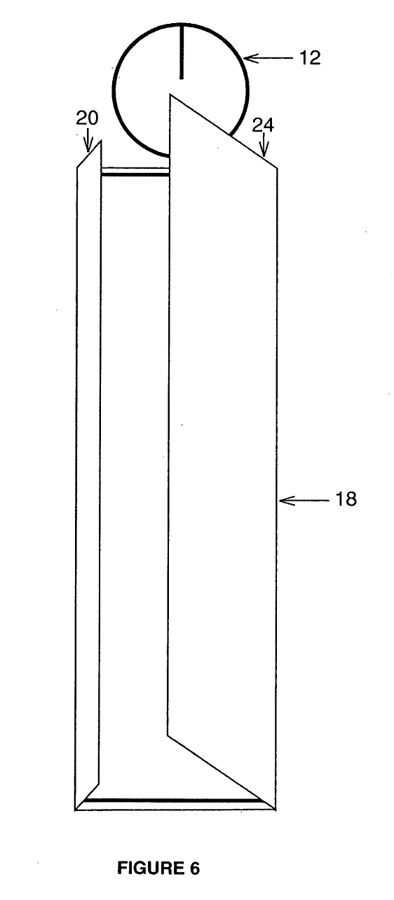

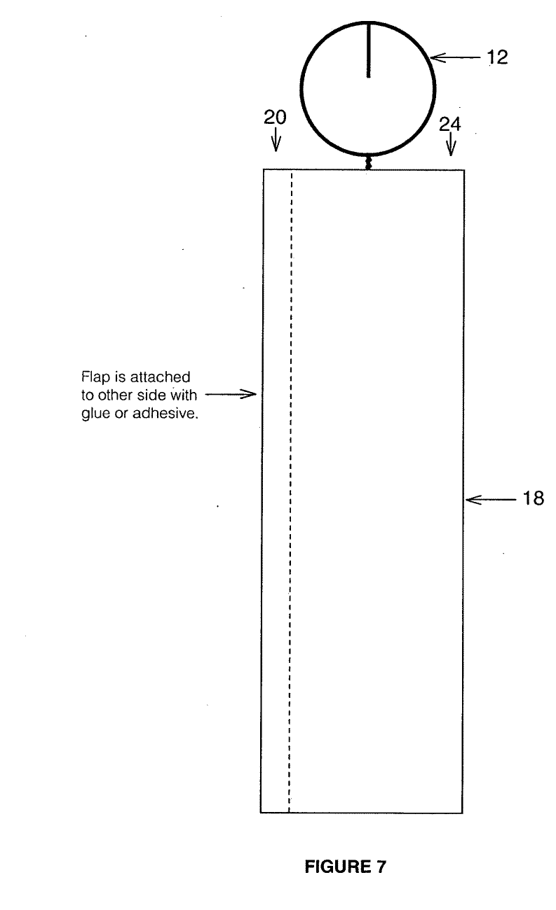

FIG. 4 displays the step of placing the frame 12 within the second portion 22 of the textual cover 18. FIG. 5 displays the step of placing the frame 28 having the hanging arm 26 that swings within the second portion 22 of the textual cover 18. FIG. 6 displays the step of folding the first portion 20 and the third portion 24 of the textual cover 18 around the frame 12. In FIG. 7, the step of securing the first portion 20 to the third portion 24 of the textual cover 18 is illustrated. In one embodiment, an adhesive secures the first portion 20 to the third portion 24.

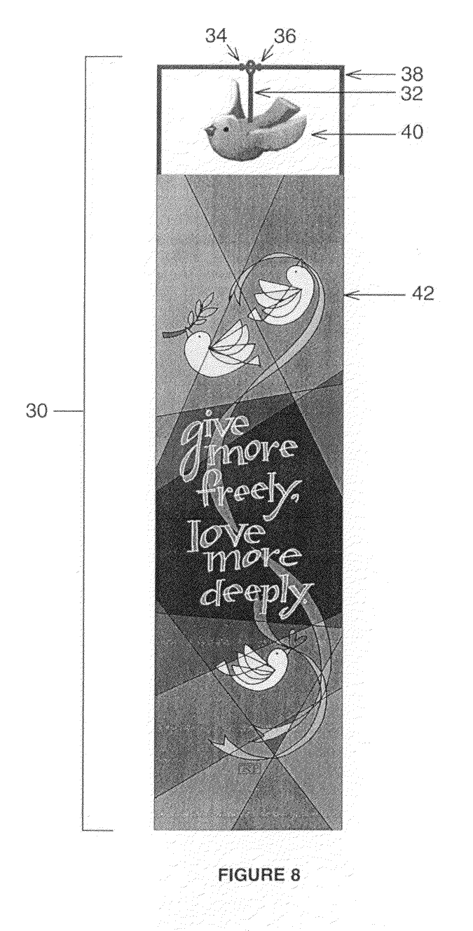

FIG. 8 depicts an embodiment of the present invention in which the bookmark 30 has one hanging arm 32 that is loosely attached to the frame 34 in a manner that allows the hanging arm 32 to swing. Two stoppers 34, 36 are disposed on each side of the hanging arm 32 to prevent the hanging arm from sliding along the frame 38. A decorative piece 40 is secured to the hanging arm 32. A textual cover 42 is disposed on a portion of the frame 38.

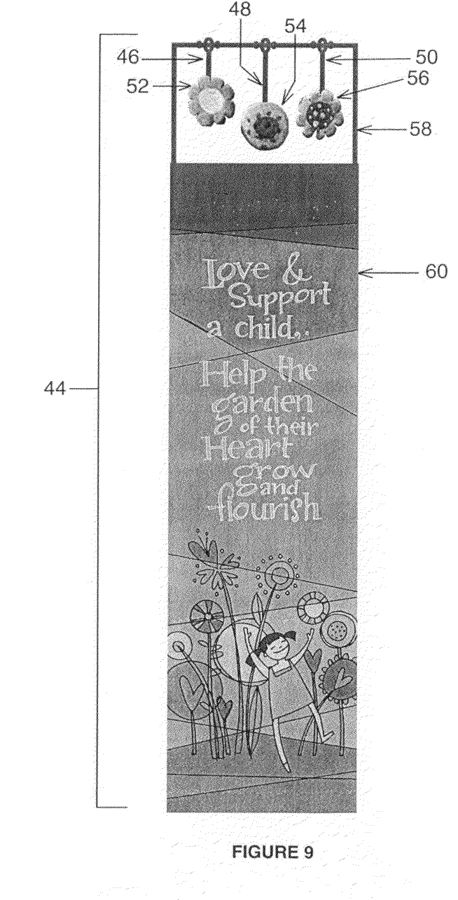

In another embodiment as shown in FIG. 9, the bookmark 44 includes a frame 58, three hanging arms 46, 48, 50, three decorative pieces 52, 54, 56, and a textual cover 60. In this embodiment, the hanging arms 46, 48, and 50 are loosely attached such that the hanging arms may swing. In another embodiment, the hanging arms may be welded securely such that the decorative piece does not move.

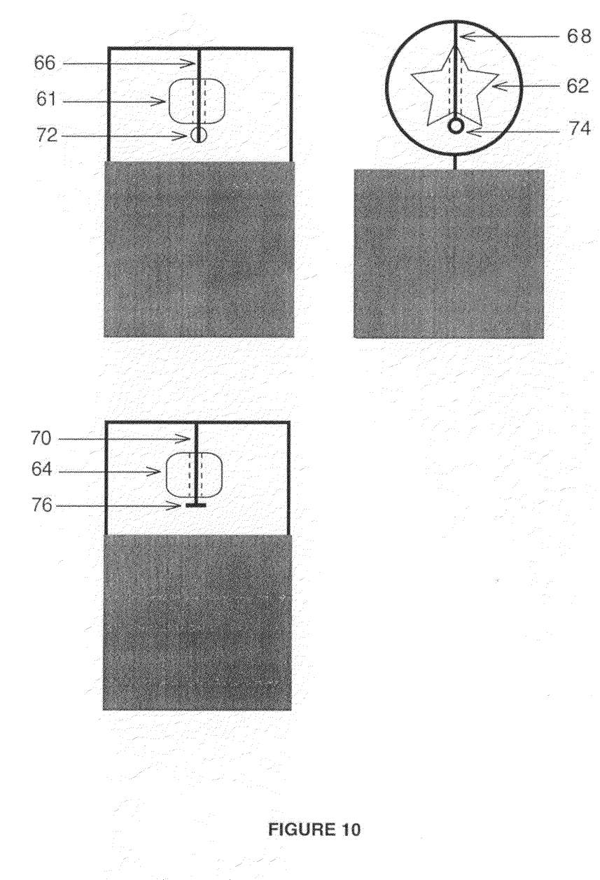

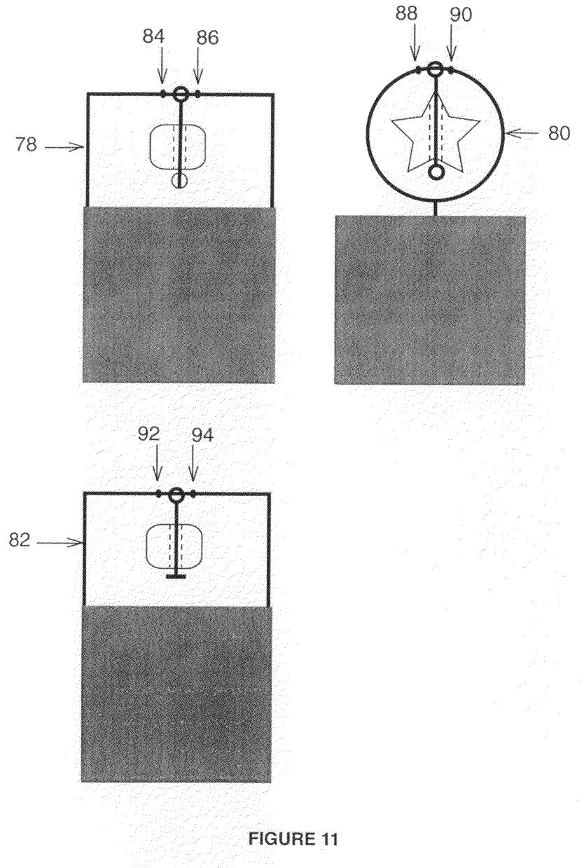

As shown in FIG. 10, the decorative pieces 61, 62, and 64 may be secured to the hanging arms 66, 68, 70 through various means. Decorative piece 61 is secured by placing a bead 72 at the end of the hanging arm 66. Decorative piece 62 is secured by a forming a loop 74 with the end of the hanging arm 68. Decorative piece 64 is secured by a stopper 76. In another embodiment as shown in FIG. 11, the frames 78, 80, 82 are each provided with a set of stoppers 84, 86; 88, 90; and 92, 94 respectively. As discussed above, these stoppers prevent the hanging arm from sliding along the frame.

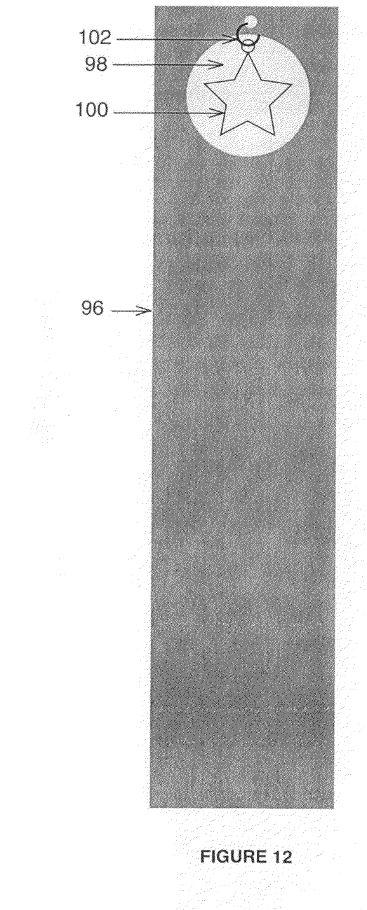

In another embodiment as shown in FIG. 12, a textual cover 96 is placed over a wire frame (not shown). A portion of the textual cover is cut out to form an opening, such as hole 98, and a decorative piece 100 is secured/attached to the textual cover 96 via a loop 102. The decorative piece 100 is positioned within the hole 98. In an alternative embodiment, bookmark of FIG. 12 is altered so that no wire frame is used. Instead, the textual cover is a plastic material that contains hole 98 and has the decorative piece attached and positioned in the manner described previously.

The foregoing description is provided to illustrate the invention, and is not to be construed as a limitation. Numerous additions, substitutions and other changes can be made to the invention without departing from its scope as set forth in the appended claims.

1. A bookmark, comprising:
a frame comprising at least three legs joined together in a serial manner; and
a decorative piece attached to one of said at least three legs of said frame.

2. The bookmark of claim 1, further comprising a textual cover, wherein said textual cover is disposed on a portion of said frame.

3. The bookmark of claim 1, wherein said frame forms a polygon.

4. A bookmark, comprising:
a frame comprising at least three legs joined together in a serial manner; and
a textual cover, wherein said textual cover is disposed on a portion of the frame.

5. The bookmark of claim 4, further comprising a decorative piece attached to said frame.

6. The bookmark of claim 4, further comprising a decorative piece attached to said textual cover.

7. The bookmark of claim 6, wherein said textual cover defines an opening and said decorative piece is positioned within said opening.

8. The bookmark of claim 4, wherein said frame forms a polygon.

9. The method of using a bookmark, the method comprising:
providing a bookmark comprising:
a frame comprising at least three legs joined together in a serial manner; and
a decorative piece attached to said frame; and
using said bookmark to mark a page location among pages of a document.

10. The method of claim 9, wherein said bookmark further comprises a textual cover, wherein said textual cover is disposed on a portion of the frame.

11. The method of using a bookmark, the method comprising:
providing a bookmark comprising:
a frame comprising at least three legs joined together in a serial manner; and
a textual cover disposed on a portion of the frame; and
using said bookmark to mark a page location among pages of a document.

12. The method of claim 11, wherein said bookmark further comprises a decorative piece attached to said frame.

13. The method of claim 11, wherein said bookmark further comprises a decorative piece attached to said textual cover.

14. The method of claim 13, wherein said textual cover defines an opening and said decorative piece is positioned within said opening.

15. A bookmark, comprising:
a textual cover defining an opening; and
a decorative piece attached to said textual cover and positioned within said opening.

16. The method of using a bookmark, the method comprising:
providing a bookmark comprising:
a textual cover defining an opening;
a decorative piece attached to said textual cover and positioned within said opening; and
using said bookmark to mark a page location among pages of a document.
